(19) United States
(12) Patent Application Publication
(10) Pub. No.: US 2015/0178682 A1
(43) Pub. Date: Jun. 25, 2015

(54) METHOD AND SYSTEM FOR CONFIDENTIALLY AND ANONYMOUSLY MATCHING JOB CANDIDATES WITH JOB OPPORTUNITIES

(71) Applicant: PROVIO, INC., ROAD TOWN (VG)

(72) Inventors: WILL MATTHEWS, CALGARY (CA); JONATHAN HATCH, HONG KONG (CN); MIKA PURRA, SINGAPORE (SG); ABASS YOUSAFZAI, LAHORE (PK); ASAD YOUNIS, LAHORE (PK)

(73) Assignee: PROVIO, INC., ROAD TOWN (VG)

(21) Appl. No.: 14/138,214

(22) Filed: Dec. 23, 2013

(51) Int. Cl. G06Q 10/10

(52) U.S. Cl. CPC G06Q 10/1053

(57) ABSTRACT

A method for matching job candidates with job requirements in a Confidential Resume System operating on a distributed computer-based network. A recruiter can identify a preselected number of first level candidates by performing one or more candidate searches on the system. The system provides candidate data, but that information is redacted to withhold information that personally identifies the candidate. Also, to provide adequate information security, each party determines whether it desires to identify itself to the other party. If a party does not desire to identify itself, the system redacts all information capable of individually identifying that party. On the other hand, if a party does desire to identify itself, the system conducts all communications without redaction.

### TECHNICAL FIELD

The present disclosure deals generally with field of personnel recruiting, and more specifically with the field of evaluating job opportunities and job candidates.

### BACKGROUND

Although the process of identifying relatively low level jobs has become somewhat automated, the same cannot be said of job opportunities involving skilled candidates on one hand and in-house or professional recruiters on the other. At lower levels, a number of Internet websites are available to both job seekers and hiring companies. In those situations, neither the job seeker nor the hiring company feels a great need for confidentiality, so job seekers tend to post resumes or applications that completely identify themselves, and companies post job notices with full information about the company, the hiring location, and so on. In those circumstances, job seekers and hiring companies can find each other relatively efficiently.

The same cannot be said for jobs at a level typically involving in-house or professional recruiters on one side and skilled or executive jobseekers on the other. There, both sides desire high levels of confidentiality. On the hiring side, the fact that a position has come open, or will be open in the near future, may not be public knowledge. A company may wish to hold that knowledge relatively close, even where the previous employee has already left the company for competitive reasons. Similarly, jobseekers may also wish to maintain a high level of confidentiality. On their side, the job seeker most likely does not want the fact that she is looking for a job to become known to a present employer. If the job seeker is currently unemployed, he may not wish to reveal that fact at an early stage of discussion with a new company.

At the present time, both job seekers and hiring companies must rely upon the discretion of recruiters to maintain the levels of confidentiality. Further, recruiters are crucial to matching job requirements with appropriately skilled candidates. Recruiters generally can be counted upon to accomplish that task, but only at the cost of inefficiency. The necessity of a recruiter's personal involvement, together with the inefficiencies inherent in requiring all communication to go through the recruiter, imposes costs in terms of time, effort and monetary expense.

Thus, the art remains in need of a process that both speeds up and streamlines the recruiting process for both job seekers and hiring companies. Yet, any due process must maintain the confidentiality of both parties well into initial discussions.

### SUMMARY

One aspect of the present disclosure addresses a method for matching job candidates with job requirements in a Confidential Resume System operating on a distributed computer-based network. This method begins by populating a database with job candidate data, while also accepting one or more job descriptions into the system from a recruiter, each job description containing a set of job criteria. Then, a recruiter can identify a preselected number of first level candidates, by performing one or more candidate searches on the system, and then employing the system to relate job criteria to job candidate data. In that manner, the system provides data regarding the first level candidates to the recruiter. This information is redacted to withhold information that personally identifies the candidate. Communications can proceed between the recruiter and one or more candidates. To provide adequate information security, each party determines whether it desires to identify itself to the other party. If a party does not desire to identify itself, the system redacts all information capable of individually identifying that party. On the other hand, if a party does desire to identify itself, the system conducts all communications without redaction.

The foregoing and other objects, aspects, features, and advantages of the present disclosure will become apparent from the following description, the drawings, and from the claims.

### BRIEF DESCRIPTION OF THE DRAWINGS

The accompanying drawings, which are incorporated in and constitute a part of this specification, illustrate exemplary embodiments of the present disclosure, and together with the description, serve to explain the principles of the disclosure. Wherever possible, the same reference numbers will be used throughout the drawings to refer to the same or like parts.

FIG. 1A is a schematic diagram of an embodiment of the present disclosure, in its operating environment.

FIG. 1B is a block diagram of an embodiment of the system of the present disclosure.

FIG. 2 is a screenshot illustrating operation of an embodiment of the system and method of the present disclosure.

FIG. 3 is a screenshot illustrating further operation of an embodiment of the system and method of the present disclosure.

FIG. 4 is a flowchart setting out a method for matching job candidates to job opportunities within an embodiment of the present disclosure.

FIG. 5 is a flowchart illustrating a method for conducting communications between job candidates and recruiters in an embodiment of the present disclosure.

FIG. 6 is a flowchart illustrating message flow between job candidates and recruiters in an embodiment of the present disclosure.

### DESCRIPTION

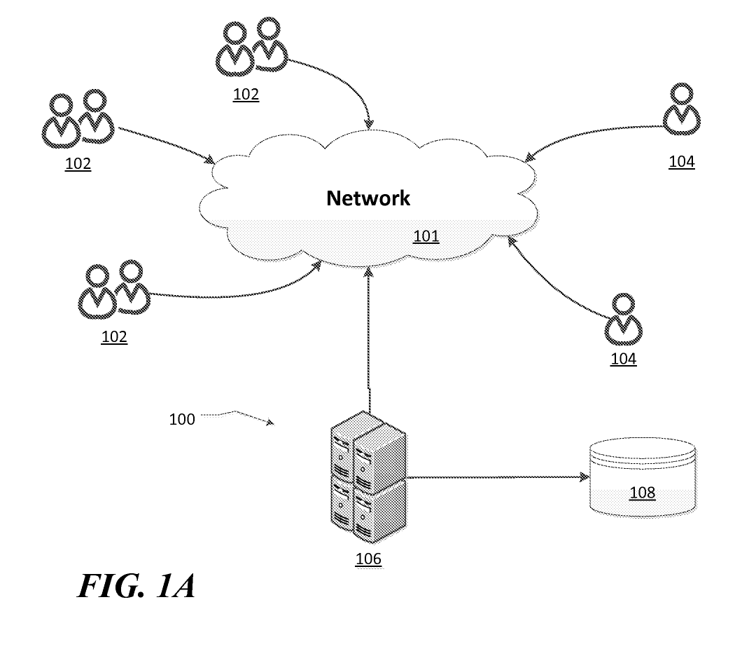

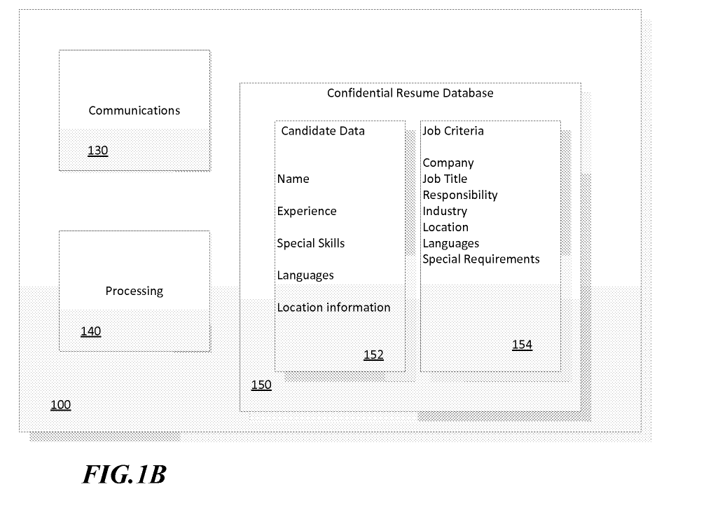

FIG. 1A depicts a Confidential Resume System 100 that embodies the present disclosure, located in its operating environment. As can be seen there, all of the various components and actors intercommunicate through a network 101. That network can be any network of sufficient scope, size, and capability to interconnect all of the various actors in a given system. For example, in an embodiment sized to serve persons interconnected by wired communications, the network could be a fully wired system. More conventionally, where users and hardware components are spread over a wider area, the network could support wireless communications over a wide area network (WAN) or the Internet. The wide variety of implementations of network 101 are well understood by those in the art, and they require no further discussion here.

The human actors who make use of system 100 are generally divided into job candidates 102 and recruiters 104. Job candidates 102 can be any persons either actively seeking a new job position or those merely keeping up to date on employment opportunities. These persons are characterized as typically having resumes or CV's prepared for distribution in connection with their job search. Other human actors are bundled into the designation “recruiters” 104. This group can be exemplified by professional recruiters, persons who serve as intermediaries between companies seeking new employees and job candidates. Such persons can be employed by recruiting firms, or they can be independent actors. Other persons within this group can be working directly for companies seeking new employees. Although differences exist between the various subgroups here, those differences are not significant in this context. Thus, all persons on the hiring side of the equation will generically be referred to as “recruiters.”

That said, the job candidates 102 may perceive a difference in the quality of job opportunity or communication based on the type of recruiter 104. For example, an employed person may perceive a message from a recruiter that works at the company that is hiring as more serious and interesting than a recruiter who is retained on a contingency basis to find an employee. The system may contain a notification with its messages disclosing the type of recruiter making contact.

System 100 resides on a server 106, supported by data storage 108. Here, the term “server” should be understood in its broadest sense, implying a computer system capable of running designated software to provide services to users. Those users may be, but are not required to be, located remotely from the server. Moreover, system 100 may be structured as “software as a service,” where no portion of system 100 resides at a user location, so that users employ communication software, such as a browser, to employ system 100 at a distance. Other embodiments may be structured in a client-server architecture, so that some portion of the system operates at a user location, while the larger part of the system operates on server 106. These and other variations and architectural structure all fall within the scope of the present disclosure. Storage 108 may be any of the variety of storage devices known and available to the art. Data stored in storage 108 may include program data, user account files, and user data files, such as copies of resumes or CV's.

FIG. 1B is a block diagram of an embodiment of system 100. As noted above, embodiments of the system 100 can take a wide number of forms, all capable of performing the method set out in the present application. The implementation of system 100 sets out an Internet-based system offering a website on which job candidates 102 and recruiters 104 can interact to effect an efficient yet confidential matching of candidates and opportunities. In general, system 100 includes a communications module 130, a processing module 140, and a Confidential Resume Database Module 150. Each of those modules will be discussed in detail below. It will be understood that those in the art are capable of choosing from among the variety of development tools known and available to the art that can be used to construct system 100.

Communications module 130 and processing module 140 are generally conventional, requiring no detailed elaboration here. Communications module 130, for example, provides communications capabilities that allow system 100 to communicate with users via network 101. Such communication generally takes place employing the TCP/IP protocol, as well known in the art. Similarly, processing module 140 performs the processing functions as laid out in this application, employing non-systems and algorithms to effectuate those functions. No further discussion is required of either communications module 130 or processing module 140.

Confidential Resume Database (CRD) module 150 may be implemented by an enterprise-level database management system, such as well-known systems provided by suppliers such as Oracle, SQL Server, and MySQL. Specific modules within CRD 150 include a candidate data module 152 and a job criteria module 154. The former module contains job candidate data, consisting of information regarding a number of individual candidates 102. At a minimum, data contained in candidate data module 152 could include the candidate's name, job experience, special skills, languages, and location information. In an implementation of system 100 geared toward a specific industry, fields may be provided to capture specific information of particular importance in that industry and may be user defined. One technique could limit a description of job responsibility to a small number of words, typically a maximum of ten words. Note that the job seeker has to fit their experience into this category so that the recruiter can search for them. For example, if a given job required a technical background, specific fields could be provided to capture undergraduate and graduate education, including subject matter, and educational institution.

In one embodiment, job candidate data may include a public profile and a complete profile for each candidate. A complete profile, as the name suggests, contains information that would be found in a full resume, including specific employers and positions held, educational degrees and institutions, and particularized concrete accomplishments. Clearly, a candidate would view quite a bit of such information as highly personal, to be revealed only to very serious potential employers, at a late point in the evaluation cycle. In addition to the full profile, a candidate could also be allowed to provide a “public profile”, including an accurate but generalized view of the candidate. Rather than specific employers and timelines, an industry picture can be presented, for example. Similarly, education and training can be set out in rather vague terms, avoiding information that could identify the candidate. Accomplishments could likewise be framed generally, stating, for example, that the candidate has been awarded ten U.S. patents, without specifying the inventions or other data. This system provides a middle ground between full disclosure and a completely masked approach, giving a potential employer a broad-brush view of a candidate that can pique interest without endangering the candidate's privacy.

Job criteria module 154 contains information about job opportunities. Data that could be captured here could include information such as the company, job title, job responsibility, industry, location, language requirements, and special requirements. One technique could limit a description of job responsibility to a small number of words, typically a maximum of ten words. This limitation requires recruiters to distill job requirements down to their essence. That level of specificity could assist in carefully matching individuals to specific jobs even before a detailed interaction begins. Fields can be provided for other data as needed. For example, a particular license may be required, so that a job in the financial sector may include a notation that SEC FINRA licensing must be current. Further detail is set out below.

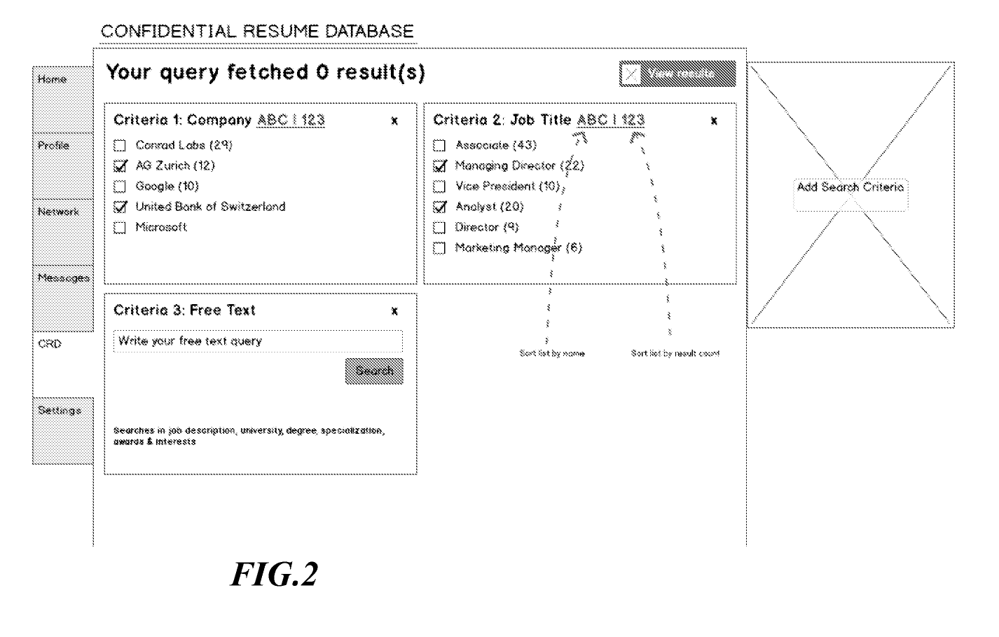

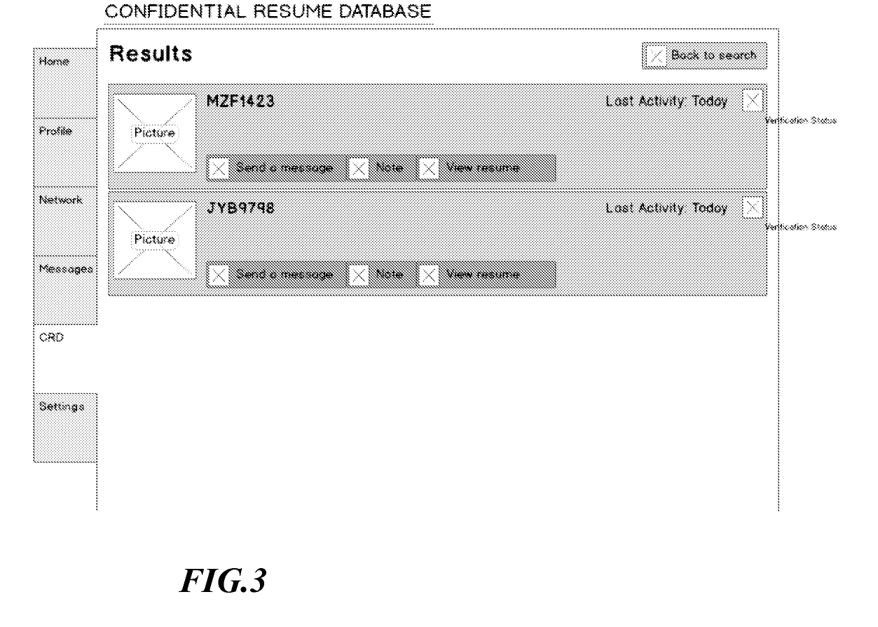

FIGS. 2 and 3 present screenshots from an embodiment of system 100, showing how data captured in CRD 150 can be displayed to a user. In FIG. 2, a user is in the midst of structuring a query based on a number of job criteria. In this embodiment, queries can be structured in an entirely free-form manner. Here, the user is a person searching for candidates to fill a particular job, and he has chosen to structure a query based on three criteria: Company, Job Title, and free text. For each of the first two criteria, the system offers the user a choice of criteria, based on data in the system. Thus, the system might display a list, perhaps in the form of a pull-down list, showing all of the companies represented in the Job Criteria Module. Or, as here, based on criteria such as matching the candidate's experience with the types of positions available, the system may offer a list of companies with seemingly suitable job opportunities. The same rationale holds for the job title selections. For each criterion, the user selects one or more listings. The Free Text field allows the user to enter a keyword likely to be found in opportunities of particular interest. As noted, the user can also select our responses will be sorted, based on either alphanumeric order or relevance.

Candidates may access the database by executing a search such as the one set out above, but candidates will most likely consult a job postings area on the website, where applicants can read positions and apply if interested. Applications to job postings may be made on a confidential basis (with name and other personal information redacted) or with personal information. A matching service may be provided, allowing the service to notify candidates about new listings that may be of interest.

The screenshot of FIG. 3 displays the results of a search performed on the Job Candidate module 152. Here, the search has returned two responses. Note that the selected candidates are not identified, but rather they are shown in connection with a code number. The system maintains complete anonymity by assigning a code to each system user, and that code is employed exclusively to identify persons on both the recruiting and candidate sides. No names or pictures are displayed. For example, if a recruiter hits the “View Resume” button, the candidate's resume will be displayed, but all identifying information will be redacted. In this manner, absolute confidentiality of the candidate's identity is maintained.

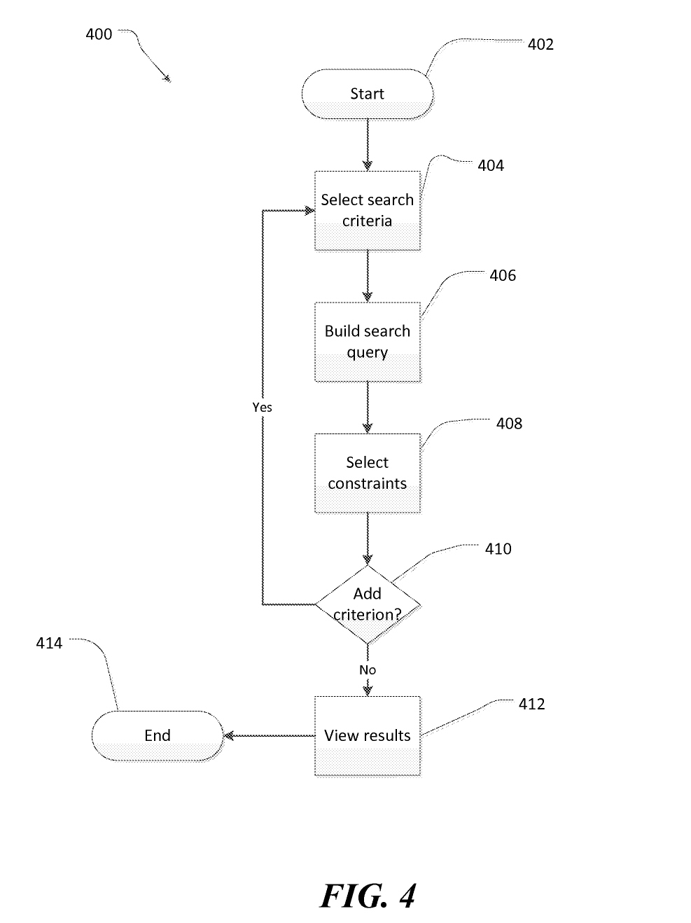

The process of performing a search is illustrated in the flowchart of FIG. 4. The illustrated search is geared particularly to a recruiter search, but it should be understood that the search flow for a candidate will be substantially the same. As shown, one initiates a search at step 402, by identifying search criteria. Here, a user would log on to the system, employing a username and password, and he would provide basic information related to the search. Beginning at step 404, the user would construct a query, the first that being to select a search criterion, such as job title. Then, in step 406 the information required to search on a particular criterion would be entered, such as a particular identifier. Depending on the structure of the system, various Boolean or pre-defined operators can be employed here. If a recruiter specifically seeks candidates with experience at IBM for example, the search might begin by selecting the “Company” criterion. If the system required manually input information, as opposed to providing a pick list, the query might be fleshed out by indicating that hits could be defined by fields containing “IBM” or by fields containing “International Business Machines.”

Once the basic information about a criterion is entered, step 408 allows the user to select constraints. Such factors might apply to the field information itself, or they might look to the relation between fields. In the first instance, one might apply features such as word stemming, which allows use of wildcard operators. Under such a system, and entry “informat*” could use the * as a wildcard operator, so that entries containing either “information” or “informative” would be returned. In some fields, the use of wildcard searches could be limited, allowing for focused results. Applied to the relationship between fields, Boolean operators could be employed to require that stated criteria be returned in multiple fields, so that a hit would be recorded only for the combination of “international” AND “business”. Those in the art will be familiar with Boolean operators, and that subject need not be addressed further here. these can also be fields such as time, job description (to be selected from a list of pre-determined names)—this is more unique than free text search

After providing information about a single criterion, the user is given an opportunity to add criteria, at step 410. A ‘yes’ response there loops back to step 404, where the criteria selection takes the user through steps 404, 406, and 408 one more time. When the user has selected a complete set of criteria, he answers ‘no’ at step 410, at which time search is run. Results are displayed at step 412. Afterward, the user can end the session at step 414.

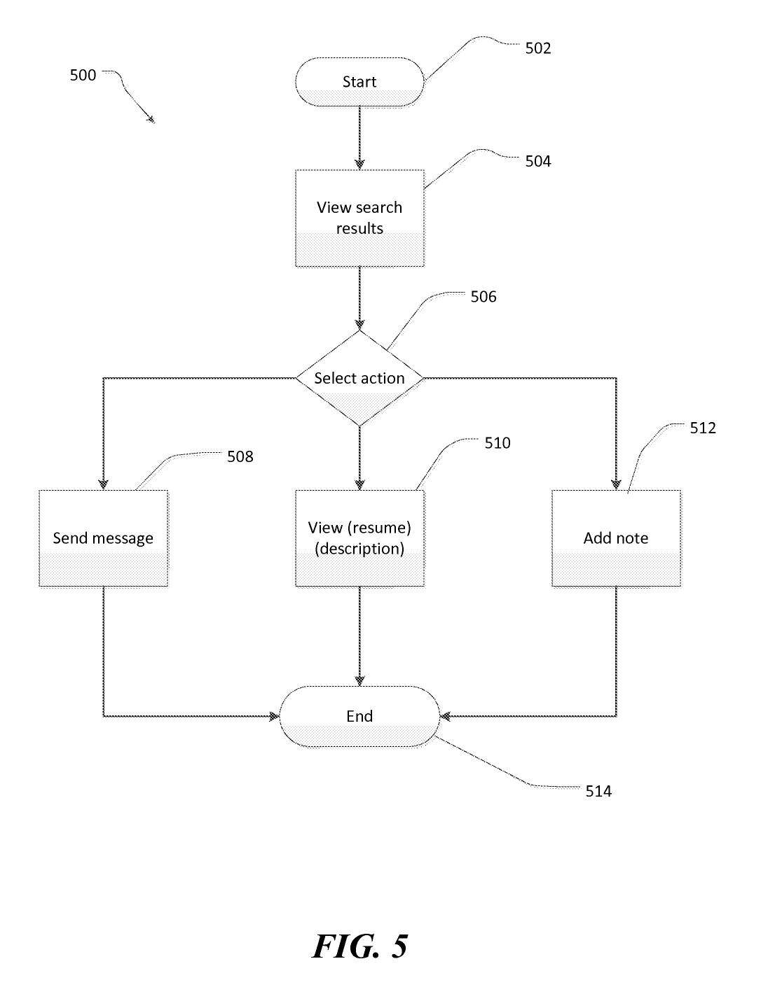

A method for working with search results appears in FIG. 5. There, after starting at step 502, the system moves to search results at step 504. Here, the system will display results in a foremost convenient way to the user. In general, results will be displayed on a computer screen for further action. That screen may be at a conventional desktop or laptop system, or a user may be interacting with the system through a mobile device, such as a smartphone or a tablet computer. In any event, results are displayed together with a set of actions available to the user (step 506). It will be readily understood that the system may present a wide variety of actions for user selection. Here are three actions will be addressed: messaging, viewing, and noting.

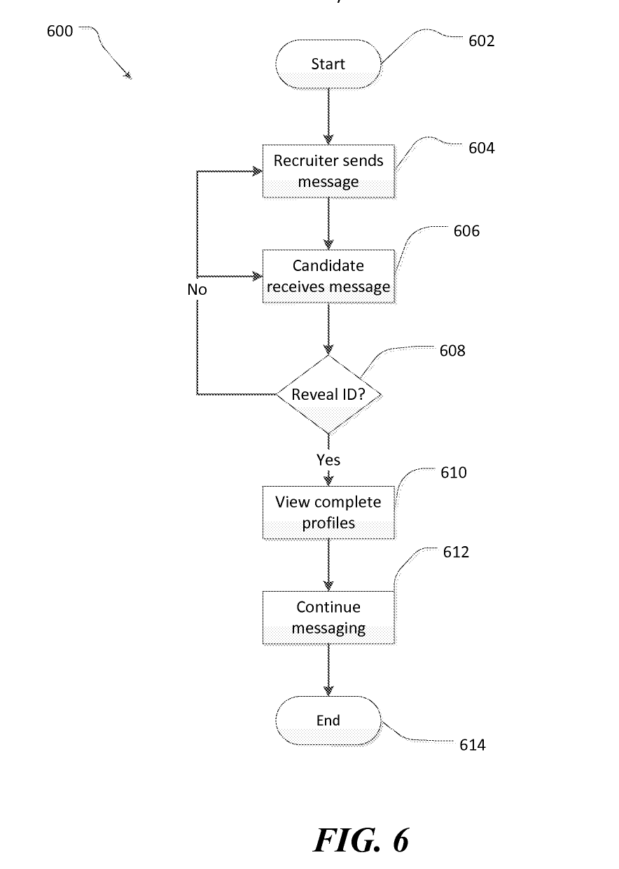

Messaging, addressed in step 508, together with the redacting of personal information as detailed above, is perhaps the most important function of those listed here. After identifying a short list of candidates (recruiter side) or if a candidate elects to apply to a listed job opportunity (candidate side) the next critical step is opening communications. It was noted above, however, that communications is fraught with peril for both sides. A candidate does not want to be prematurely identified, nor does a company want the knowledge that a position is open to be broadcast about the community. The dangers here are very real, yet the art has not gone beyond human discretion in ameliorating risk. The present disclosure addresses this problem first by providing secure, confidential communication channel. Most communications requires knowing the identity of the addressee; here, the system knows the identity of the addressee in both cases, but the sender does not. From either side, the fact that the system is managing the message system provides truly double-blind communication. Message traffic can pass back and forth, with neither side knowing the identity of the other party. The messaging process will be discussed more fully in connection with FIG. 6.

Alternatively, the user can view more information about the selection, by seeing either the resume (recruiter side) or the job description (candidate side) step 510. Again, the system automatically removes all identifying information before forwarding the document to the reader. Just as communication proceeds in a double-blind fashion, information gathering does the same. The process of removing identifying information is automated and customizable. In an automated fashion, the system removes information such as the name and location of a company, names of individuals, and the like. When information is added to the system, a user may flag other information as being critical. For example, the name of a product might specifically identify a given company, while the names of particular publications might identify an individual. In either event, the system and the user can work together to ensure complete anonymity.

In some embodiments, as noted above, a third tier of candidate information can be provided, in the form of a “public profile” that sets out candidate information in a generalized form. Here the employer can learn accurate, important information, but that information will not allow identification of the candidate.

Finally, the system may provide facility for a user to make notes while going through a particular item. A recruiter can annotate a resume, for example by highlighting particular areas for follow-up in a later interview or their impressions of the communication with the candidate. Those annotations will appear only on the writer's copy of the resume, so one can make extensive notes without compromising security. Similarly, a candidate can indicate questions related to the opportunity. This process ends at step 514.

A method for handling message flow is set out in FIG. 6. After beginning its step 602, a recruiter sends a message to a candidate at step 604. This example assumes that the recruiter is sending a message, but the same information applies when the messages flowing in the opposite direction, with the candidate as the sender. It is important to note that the recruiter does not worry about confidentiality when drafting the message or when sending it. The system automatically redacts information that would identify the recruiter. That information includes obvious identifiers, such as a company name, as well as information identified by the recruiter as being a security risk. Thus, when the candidate receives the message at step 606 the candidate is not aware of the identity of the company. Further, the recruiter does not know the identity of the candidate receiving the message. Communication proceeds in a double-blind fashion until one or both of the parties agree to reveal themselves.

At step 608, the parties can decide whether or not to reveal their identities. Where a “public profile” is provided by candidates, the step will add that option to the list of possible choices. If parties do not reveal identities at that time, communication proceeds as outlined above, until such time as one or both of the parties agree to reveal identities 1. As soon as one or both parties have revealed identities, the process moves to step 610, where the system displays the profile of whichever party (or both) has revealed itself. Both sides then continue messaging (step 612) until a decision is taken either to extend an offer or to discontinue further discussions.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable other skilled in the art to best utilize the disclosure and various embodiments with various modifications as suited to the particular use contemplated.

We claim:

1. A method for matching job candidates with job requirements in a Confidential Resume System operating on a distributed computer-based network, the method comprising
populating a database with job candidate data;
accepting one or more job descriptions into the system from a recruiter, each job description containing a set of job criteria;
identifying a preselected number of first level candidates, including
performing one or more candidate searches on the system, employing the system to relate job criteria to job candidate data;
providing data regarding the first level candidates to the recruiter, the data being redacted to withhold information that personally identifies the candidate;
transmitting communications between one or more candidates and the recruiter, including
determining whether the communicating party desires to identify itself to the other party;
upon an indication that the communicating party does not desire to identify itself, redacting all information capable of individually identifying the communicator;
upon an indication that the communicating party does desire to identify itself, transmitting that and all further communications without redaction.

2. The method of matching job candidates with job requirements of claim 1, wherein the job candidate data includes a public profile, containing information the candidate is willing to share with a recruiter under conditions of relaxed confidentiality.

3. The method of matching job candidates with job requirements of claim 1, wherein the job candidate data includes a public profile, containing information the candidate is willing to share with a recruiter under conditions of relaxed confidentiality, and a complete profile, containing information the candidate is only willing to share under conditions of complete confidentiality.

4. The method of matching job candidates with job requirements of claim 2, wherein the shared data are generalized to prevent specific identification of the job candidate.

5. The method of matching job candidates with job requirements of claim 3, wherein the shared data are generalized to prevent specific identification of the job candidate.

6. The method of matching job candidates with job requirements of claim 1, wherein populating the database with job candidate data includes specifying customized criteria for providing redacted information.

7. The method of matching job candidates with job requirements of claim 6, wherein providing redacted information includes redacting job candidate data employing preselected redaction criteria.

8. The method of matching job candidates with job requirements of claim 1, wherein the job description data includes a public profile, containing information the recruiter is willing to share with a job candidate under conditions of relaxed confidentiality.

9. The method of matching job candidates with job requirements of claim 1, further comprising annotating job candidate data, the annotations being available only to the recruiter performing such annotations.
